(19) United States
(12) Patent Application Publication
(10) Pub. No.: US 2007/0265982 A1
(43) Pub. Date: Nov. 15, 2007

(54) Methods and computer program products for licensing software to multiple user classes

(75) Inventors: Lehtola Juha Kalervo, Raisio (FI); Ingrid Rokahr, Munkfors (SE); Viskari Kirsi-Marja, Imatra (FI)

Correspondence Address: MYERS BIGEL SIBLEY & SAJOVEC, PO BOX 37428, RALEIGH, NC, 27627, US

(73) Assignee: Stora Enso OYJ

(21) Appl. No.: 11/801,193

(22) Filed: May 9, 2007

Related U.S. Application Data
(60) Provisional application No. 60/798,841, filed on May 9, 2006.

(51) Int. Cl. H04L 9/00

(52) U.S. Cl. 705/59

(57) ABSTRACT

Provided are methods and computer program products for licensing software to multiple user classes. Such methods may include collecting a software license fee corresponding to a software application from a key user interested in using and/or licensing the software application and collecting, from the key user, a priority usage-based license fee corresponding to usage of the software application by a priority user.

### CROSS-REFERENCE TO RELATED APPLICATIONS

This application claims the benefit of and priority to U. S. Provisional Patent Application No. 60/798,841, filed May 9, 2006, the disclosure of which is incorporated herein by reference as if set forth in its entirety.

### FIELD OF THE INVENTION

The present invention relates generally to software and, more particularly, to methods and computer program products for licensing software.

### BACKGROUND

Software producers and/or distributors may use software licenses to sell access to their software applications. In some cases, software licenses may be based on the number of installations of the software application. Such arrangements may be beneficial in the circumstance of a user having significant interest in using the software application on, for example, a regular basis. Some software licenses may be based on the number of users and/or the number of CPUs and/or servers running and/or capable of running the software.

Some software applications may be licensed to users based on the usage of the software application. For example, in the case of network services such as, for example, advertisements, a user may be charged a per-click fee, which correlates to the number of times a particular advertisement is selected. Other ways of providing revenue generation from a software application is based on the sale of content and/or files, such that the buyer is charged for the amount of content and/or files sent or delivered. Content-based revenue generation may be particularly applicable to software applications providing database services and/or statistics regarding user activities. The aforementioned software licensing techniques, however, do not address the licensing of software applications for multiple users having different degrees of interest and benefits.

### SUMMARY

Embodiments of the present invention are directed to methods for licensing software to multiple user classes having different degrees of interest. In some embodiments, methods may include collecting a software license fee corresponding to a software application from a key user interested in using the software application and collecting, from the key user, a priority usage-based license fee corresponding to usage of the software application by a priority user. Some embodiments may further include collecting, from the key user, a non-priority usage-based license fee corresponding to usage of the software application by a non-priority user.

In some embodiments, the priority user contributes value to the software application and the priority usage-based license fee is assessed at a priority fee rate that is different (e.g., lower, higher, etc.) than a non-priority fee rate corresponding to a non-priority usage-based license fee. In some embodiments, the priority user contributes value to the software application by populating a database with information.

The usage-based license fee of some embodiments may be a per click fee. In some embodiments, the usage-based license fee is a fee corresponding to a quantity of files transferred.

In some embodiments, the key user is a first supply chain party who derives benefit from usage of the software application by the priority user. The first supply chain party of some embodiments is a product manufacturer and/or product brand owner. In some embodiments, the product manufacturer and/or product brand owner may be legally obligated to and/or commercially motivated to verify product authenticity and/or provide a record of product delivery status. The record of product delivery status may include product location.

In some embodiments, the software application is a tracking and/or authenticating application, the key user is a manufacturer, the priority user contributes data corresponding to delivery status of a product, and the non-priority user is a consumer.

Some embodiments may be directed to a computer program product that includes computer usable storage medium having computer-readable program code embodied in the medium, such that the computer readable program code may be configured to perform the methods described herein.

Some embodiments of the present invention may be directed to a method of licensing, to multiple user classes having different degrees of interest, a software application configured to store, in a database on a server, a unique identifier corresponding to a product, connect to the server, and access related information corresponding to the unique identifier. Some embodiments of such methods may include collecting a software license fee corresponding to a software application from a key user interested in using and/or licensing the software application and collecting, from the key user, a usage-based license fee corresponding to usage of the software application by a non-key user.

In some embodiments, the usage-based license fee is a per click license fee corresponding to a quantity of selections made by the non-key user. In some embodiments, the usage-based license fee is a per file license fee corresponding to a quantity of files accessed by the non-key user. In some embodiments, the non-key user is a priority user who provides value to the software application by providing data to the database. In some embodiments, the non-key user is a non-priority user having an interest in specific data contained within the database.

Some embodiments of the present invention include methods of licensing software to multiple user classes having different degrees of interest. Embodiments of such methods may include billing a license fee to a key user for use of a software application, receiving, by a provider of the software application, value to the software application from a priority user, and providing the priority user access to the software application. Some embodiments may further include billing a priority user usage-based license fee to the key user based on usage of the software application by the priority user, providing a non-priority user access to the software application, and billing a non-priority user usage-based license fee to the key user based on usage of the software application by the non-priority user.

In some embodiments, the priority user usage-based license fee is determined by a priority user rate, the non-priority user usage-based license fee is determined by a non-priority user rate, and the priority user rate is different than the non-priority user rate.

In some embodiments, the software application is a database and wherein the value received from the priority user comprises data configured to be received by the database.

### BRIEF DESCRIPTION OF THE DRAWINGS

FIG. 1 is a block diagram illustrating a network for licensing software to multiple user classes having different degrees of interest according to some embodiments of the present invention.

FIG. 2 is a block diagram illustrating a commercial application of licensing software to multiple user classes having different degrees of interest according to further embodiments of the present invention.

FIG. 3 is a flow diagram illustrating operations for licensing software to multiple user classes having different degrees of interest according to some embodiments of the present invention.

FIG. 4 is a flow diagram illustrating operations for licensing software to multiple user classes having different degrees of interest according to further embodiments of the present invention.

FIG. 5 is a flow diagram illustrating operations for licensing software to multiple user classes having different degrees of interest according to yet further embodiments of the present invention.

FIG. 6 is a flow diagram illustrating operations for licensing software to multiple user classes having different degrees of interest according to further embodiments of the present invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g. ”, which derives from the Latin phrase “exempli gratia,” may be used to introduce or specify a general example or examples of a previously mentioned item, and is not intended to be limiting of such item. If used herein, the common abbreviation “i.e. ”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

Well-known functions or constructions may not be described in detail for brevity and/or clarity.

The present invention may be embodied as methods, systems, and/or computer program products. Accordingly, the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

Embodiments of the invention herein may be generally directed to methods and computer program products for licensing software to multiple user classes.

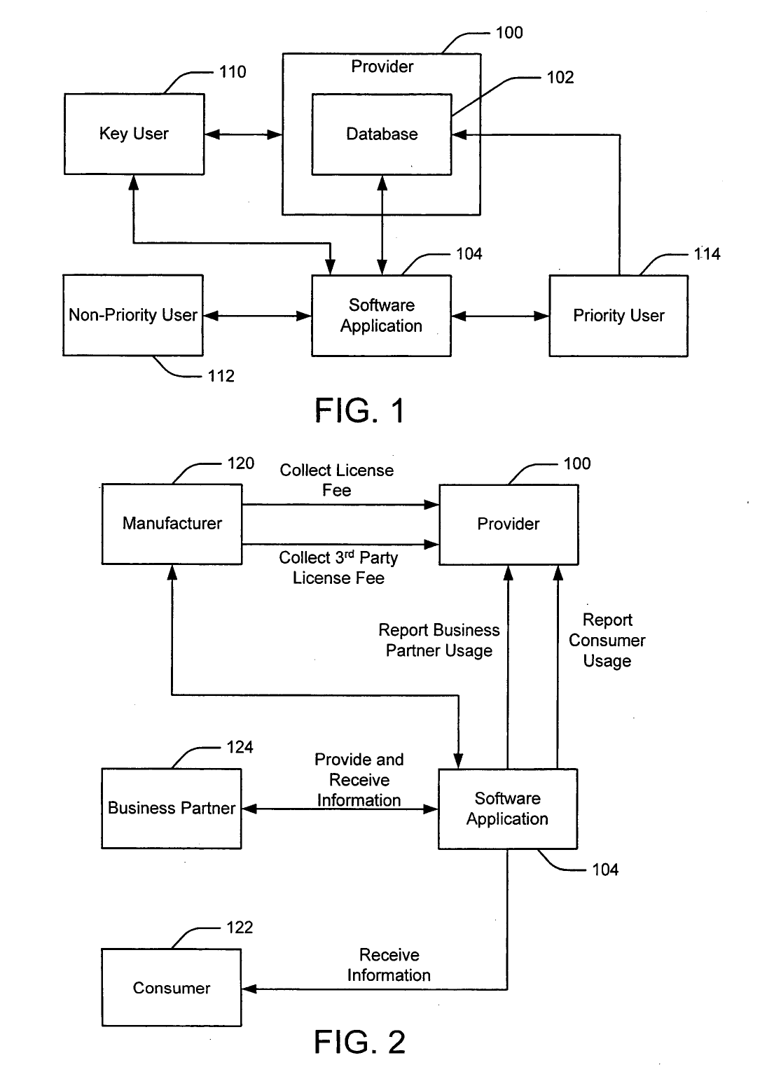

Reference is now made to FIG. 1, which is a block diagram illustrating a network for licensing software to multiple user classes having different degrees of interest according to some embodiments of the present invention. A provider 100 may provide a software application 104 configured for use by multiple classes of users having different degrees of interest in the software application 104. For example, some users may have a high degree of interest in using the software application 104, whereas other users may have varying, but lower, degrees of interest in using the software application 104. In some embodiments, the software application 104 may be utilized in conjunction with a database 102 that may be provided by the provider 100. In some embodiments, the database 102 may be provided by a third party vendor and/or unrelated entity.

In some embodiments, the software application 104 may pertain to, be related to, and/or be based on networking activities including, for example, the Internet, local area networks (LANs), and/or wide area networks (WANs), among others. Non-limiting examples of such networking activities may include, but are not limited to, tracking, tracing, authenticating and/or verifying processes, products and/or services. In some embodiments, tracking and tracing functions may be configured to provide valuable information for marketing purposes. In some embodiments, statistical data and/or analyses may be provided. In some embodiments, different classes of users may have different degrees of interest in the software application 104 and use thereof. For example, a key user 110 may have a significantly high degree of interest in using the software application 104 and thus will be willing to purchase a user license from the provider 100. Other users, such as, for example, a non-priority user 112, may have a lower degree of interest in the software application 104 and, thus, may not be motivated to purchase a user license from the provider 100. In such cases, however, the key user 110 may pay the provider 100 a usage-based license fee for the non-priority user 112 to use the software application 104. In this manner, the key user 110 may provide the additional value to the non-priority user 112 via the software application 104. In some embodiments, the license fee for a non-priority user 112 paid for by the key user 110 may be based on factors other than usage. For example, a license fee may be determined based on a finite, short-term license period.

In some embodiments, a priority user 114 may also benefit from using the software application 104. Additionally, a priority user 114 may contribute value to the software application 104 by, for example, providing data to populate the database 102. In such cases, the key user 110 may pay the provider 100 a usage-based license fee for the priority user 114. In some embodiments, the priority user 114 and the key user 110 may have substantially the same degree of interest in the software application. For example, the priority user 114 and the key user 110 may both have obligations to authenticate, verify, trace and/or track a product and/or delivery status. In some embodiments, the priority user 114 may also provide partial payment of usage-based license fees. In some embodiments, usage-based license fees for the non-priority user 112 and priority user 114 may be determined based on different rates due to the value added by the priority user 114. In some embodiments, the priority user 114 may have a lower usage-based rate than the non-priority user 112. In yet other embodiments, the priority user 114 may have a higher usage-based rate than a non-priority user 112. In some embodiments, the usage-based license fees may be determined based on a click charge that assesses a fee every time a particular link and/or function is selected within the software. In some embodiments, the usage-based license fees may be determined based on the amount of information requested and/or received. For example, a fee may be assessed per file transmitted, per data extraction from a database, and/or per report, among others. In some embodiments priority license fee may be based on factors other than usage.

Reference is now made to FIG. 2, which is a block diagram illustrating a commercial application of licensing software to multiple user classes having different degrees of interest according to further embodiments of the present invention. A provider 100 provides a software application 104 for multiple user classes having different degrees of interest in the software application 104. For example, a manufacturer 120 may have a high degree of interest in using the software application 104. To this end, the provider 100 may collect a license fee from the manufacturer 120 based on the manufacturers use of the software application 104. In some embodiments, a license fee may be based on, for example, the number of installed versions, a click fee, duration of activity and/or the number of users, etc.

While the manufacturer 120 may represent a user class having a high degree of interest in using the software application 104 and/or having the software application 104 used by others who may add value to the application, a business partner 124 may only have a moderate degree of interest in using the software application 104. For example, the business partner 124 may be involved in the supply chain of a product and/or service provided by the manufacturer 120. Thus, the business partner 124 may benefit from receiving information via the software application 104. Further, the business partner 124 may also add value to the software application 104 by providing, for example, data and/or information regarding the supply chain as applied to products and/or services provided by the manufacturer 120. Such data and/or information may be useful, for example, in the context of tracking, tracing, verifying, and/or authenticating a location and/or source of a product and/or service provided by the manufacturer 120.

A consumer 122 may have an even lower degree of interest in using the software application 104 and/or in paying for the usage of the software application 104. For example, the consumer 122 may only be interested in using the software application 104 in connection with an inquiry, purchase and/or acquisition of a product and/or service provided by the manufacturer 120. In this manner, the consumer 122 may be interested in merely receiving information regarding a specific product and/or service via the software application 104. In some embodiments, the software application 104 may include a database and/or access to a database in a centrally located and/or remotely located site. In some embodiments, the software application 104 may be distributed to any of the manufacturer 120, the business partner 124, and/or the consumer 122. Such distribution may be accomplished via a variety of computer readable media and/or electronic transmission. In some embodiments, the software application 104 may be centrally located and accessed and/or used by the manufacturer 120, the business partner 124, and the consumer 122 via wired and/or wireless communication techniques that may be utilized within a variety of network and/or communication environments.

The software application 104 may be configured to report software usage by the business partner 124 and the consumer 122 to the provider 100. In some embodiments, the provider may determine a usage-based third-party license fee, which may be collected from the manufacturer 120. The usage fee for use of the software application 104 by the business partner 124 may be determined corresponding to a priority user rate based on the value of the information provided to the software application and/or database by the business partner 124. In some embodiments, the usage fee for use of the software application 104 by the consumer 122 may be based on a non-priority user rate, which may be different than the priority user rate.

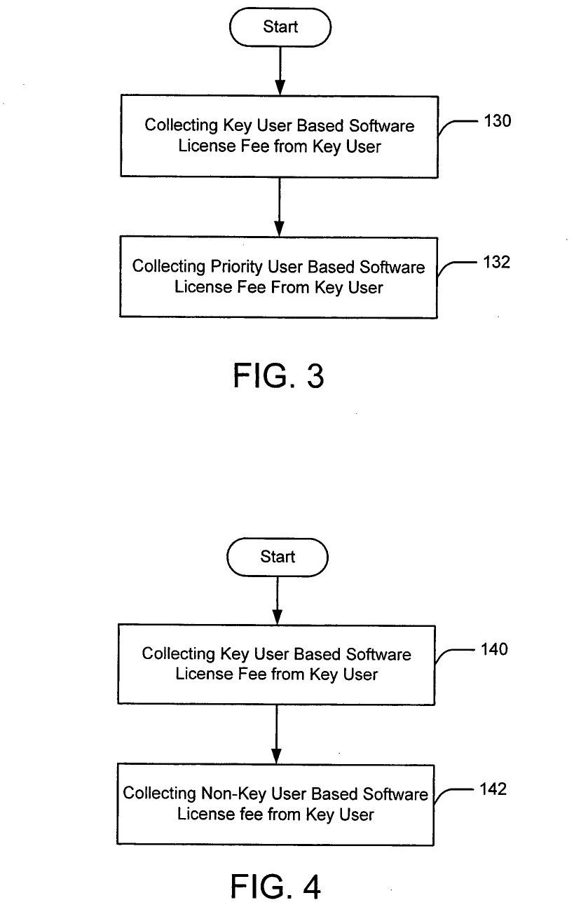

Reference is now made to FIG. 3, which is a flow diagram illustrating operations for licensing software to multiple user classes having different degrees of interest in the software application, according to some embodiments of the present invention. Operations may include collecting a software license fee corresponding to a software application from a key user have a high degree of interest in using the software application (block 130). In some embodiments, a key user may be, for example, a supply chain party who derives benefit from using the software application in providing information regarding products and/or services supplied by the key user. For example, a key user may be a product manufacturer having a legal and/or commercial obligation to verify product authenticity and/or provide a record of product delivery status. In some embodiments, product delivery status may include product location and/or additional scheduled delivery activities, etc.

In some embodiments, the software application may include a tracking and/or authenticate application configured to track, trace, verify and/or authenticating products and/or services provided by the key user. In some embodiments, the software application may include network applications, including, for example, social and/or professional networking applications and/or online topic-specific forums directed to, for example, product and/or service support. In such embodiments, a key user may be the manufacturer, a priority user may be a distributor and/or technical support provider and a non-priority user may be a customer and/or potential customer. By paying usage-based license fees for the priority user, the key user may be positioned to provide better and/or supplemental service in connection with products and/or services. For example, information provided by a priority user may increase the value of the software application and, thus, the service to customers and/or consumers.

Operations may also include collecting a priority usage-based license fee from the key user responsive to use of the software application by a priority user (block 132). In some embodiments, operations may also include collecting a non-priority used-based license fee from the key user corresponding to usage of the software application by a non-priority user. In some embodiments, a priority user may contribute value to the software application in the form of, for example, information, data, and/or statistics in support of the software application. In such embodiments, the priority usage-based license fee may be assessed such that the priority fee rate is lower than a non-priority fee rate corresponding to a non-priority usage-based license fee.

A usage-based license fee may be determined using a variety of access parameters. For example, in some embodiments the usage-based license fee may be based on each click and/or selection of a link and/or function within the software application. In some embodiments, the usage-based license fee may correspond to the quantity of files, reports and/or statistical queries provided.

Reference is now made to FIG. 4, which is a flow diagram illustrating operations for licensing a software application to multiple user classes having different degrees of interest according to some embodiments of the present invention. In some embodiments, the software application may be configured to store, in a database, a unique identifier corresponding to a product and/or service. The software application may be further configured to connect to a server and access-related information corresponding to the unique identifier. Some embodiments of licensing the software application may include collecting a license fee from a key user based on the key users use of the software application (block 140). A key user may be a user having a high degree of interest in using the software application. Some embodiments of licensing the software application may include collecting a usage-based license fee corresponding to a non-key user from the key user (block 142). In some embodiments, the non-key user may be a priority user and/or a non-priority user. In some embodiments, the priority user may provide value to the software application by, for example, providing data to the database. In some embodiments, a non-priority user may have some degree of interest in specific data contained within the database, but not provide any value to the software application. In some embodiments, the usage-based license fee may be a per click license fee corresponding to a quantity of functions accessed by the non-key user while using the software application. Functions accessed by the non-key user may include, but are not limited to, information, data, and/or file access and/or download requests. In some embodiments, functions may include authentication and/or e-pedigree verification functions, statistical and/or processed data requests, and/or historical query functions, among others. As known to those skilled in the art, e-pedigree is a record of the chain of custody of a product as it moves through the supply chain from manufacturer to a point of sale, customer, etc. The per click license fee may include different rates for different functions accessed by the non-key user. In some embodiments, some functions may not result in the assessment of the license fee at all. The usage-based license fee of some embodiments may be a per file license fee corresponding to a quantity of files and/or bytes accessed and/or retrieved by the non-key user. Such files may be pre-existing files and/or may be generated responsive to a non-key user query.

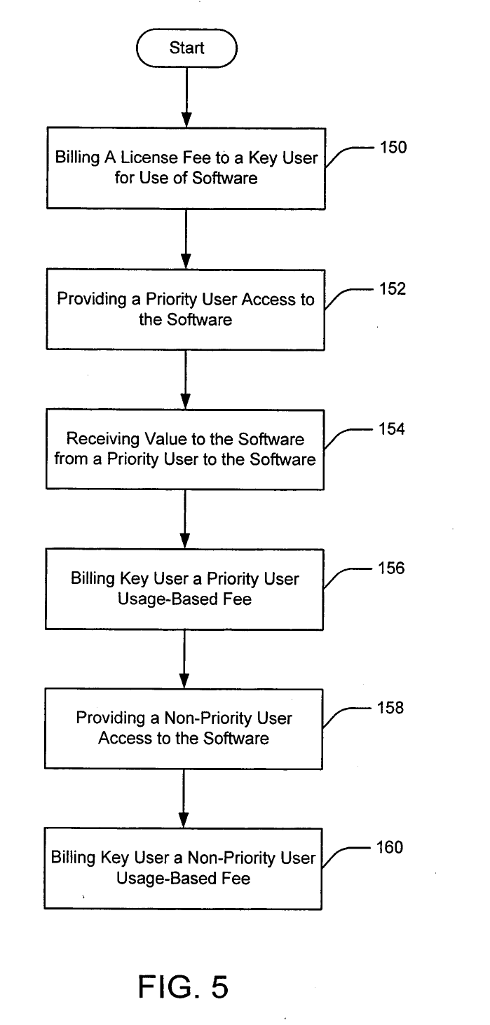

Reference is now made to FIG. 5, which is a flow diagram illustrating operations for licensing software to multiple user classes having different degrees of interest according to further embodiments of the present invention. Operations may include billing a license fee to a key user for use of a software application (block 150). The key user may have a high degree of interest in using the software application and thus may be willing to pay a license fee to a provider of the software application.

A priority user may access and use the software application (block 152). Additionally, value to the software application may be received from the priority user in the form of, for example, data and/or information related to the software application (block 154). For example, in the case of a software application for tracking delivery and/or origin of a product, a priority user may be a service provider in a supply chain and may provide information regarding the delivery status of the product. The priority user may have, by virtue of participation in the supply chain, a moderate degree of interest in utilizing the software application. Although this moderate degree of interest may not be sufficient to motivate the priority user to pay a license fee to the provider, a priority user may be motivated to provide value to the software application via data and/or information related to the supply chain, particularly if the license fee is going to be paid by the key user on the priority user's behalf.

Some embodiments provide for billing a key user corresponding to a priority user usage-based fee (block 156). The key user may be billed, based on the usage of the priority user, a priority usage rate that reflects the beneficial nature of the value provided by the priority user. As discussed above, the usage-based fee may be determined using a variety of access parameters including, for example, a per click, per file and/or per time period.

A non-key user may be provided access to the software application (block 158). The non-key user may be sufficiently attenuated from participation in the supply chain and thus only have a minor and/or temporary degree of interest in utilizing the software application. For example, the non-key user may be a consumer purchasing a product manufactured by the key user and delivered through supply channels managed by a priority user. The consumer's degree of interested in utilizing the software application may be low and temporary lasting until, for example, the purchased product is delivered. The key user may have a high degree of interest in using the software application and is motivated to ensure that the non-key user has access to the software application, also. In this manner, the key user may be billed a usage-based fee for the non-key user's access to and/or use of the software application (block 160). In some embodiments, the usage-based fee may be an initial flat rate for defined terms, such as, for example, 10 days.

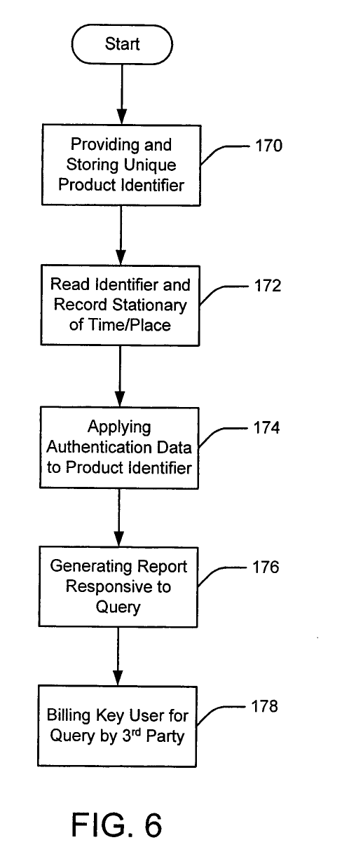

Reference is now made to FIG. 6, which is a flow diagram illustrating operations for an authentication software application provided to multiple user classes having different degrees of interest according to some embodiments of the present invention. In some embodiments, operations include providing and storing unique product identifiers corresponding to products provided by manufacturer (block 170). The unique product identifier may be stored in a central database and/or distributed to remote data storage locations. In some embodiments, additional data related to product identifiers may also be stored in the database. In some embodiments, unique product identifiers may be transmitted to one or more sites capable of running the software application. For example, in some embodiments, a software application may be configured to receive information content updates as unique product identifiers are stored, received, updated, and/or modified.

A software user, such as, for example, a user in the supply chain for the product, may read the unique product identifier and make a stationary record as to when and where the product identifier is read (block 172). By recording the time and location when the product identifier is read, the software application may be updated to reflect the most current delivery status of the product.

Authentication data may be applied to the product identifier to verify the product source and/or origin (block 174). In this manner, subsequent software users, including, for example, consumers and/or potential consumers, who read the unique product identifier, may verify the source and/or origin of the product.

A report may be generated responsive to a query from a software user (block 176). The report may include, for example, authenticating, verifying, tracking and/or tracing data regarding the product and/or the delivery status thereof. A key user, such as, for example, a manufacturer, may be billed a usage-based license fee for the query performed by a third-party user. The third-party user may be a priority user, such as, for example, the supply chain participant or may be a consumer and/or recipient of the product and/or service provided by the key user. In this manner, the key user may provide a tracking and/or authenticating service regarding the provided products.

Although as discussed herein, some embodiments may be discussed in the context of single users in different user classes, it is appreciated that the methods and computer program products herein are applicable to multiple users within each of the multiple user classes.

Although the methods herein are discussed in the context of authentication and/or tracking software applications, these applications are presented merely by way of example and are not intended to limit the methods provided herein. For example, the methods herein may be applicable and useful to a variety of network-based applications and/or services.

As will be appreciated by one of skill in the art, the present invention may be embodied as a method, system, business method and/or computer program product. Accordingly, the present invention may take the form of an entirely hardware embodiment, an entirely software embodiment or an embodiment combining software and hardware aspects, all generally referred to herein as a “circuit” or “module.”

Embodiments according to the present invention are described with reference to block diagrams and/or operational illustrations of methods, systems and computer program products for licensing software. In this regard, each block may represent a module, segment, or portion of code, which comprises one or more executable instructions for implementing the specific logical function(s). It is to be understood that each block of the block diagrams and/or operational illustrations, and combinations of blocks in the block diagrams and/or operational illustrations, can be implemented by program instructions, analog and/or digital hardware, and/or radio frequency. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium, may be, for example but not limited to, an electronic, magnetic, optical, electromagnetic, infrared, or semiconductor system, apparatus, or device. More specific examples (a nonexhaustive list) of the computer-readable medium include the following; hard disks, optical storage devices, magnetic storage devices, a portable computer diskette, a random access memory (RAM), a read-only memory (ROM), an erasable programmable read-only memory (EPROM or Flash memory), and a compact disc read-only memory (CD-ROM and/or DVD-ROM).

Computer program code for carrying out operations of the present invention may be written in an object oriented programming language such as Java®, Smalltalk or C++, a conventional procedural programming languages, such as the “C” programming language, or lower-level code, such as assembly language and/or microcode. However, embodiments of the present invention are not limited to a particular programming language. The program code may execute entirely on a single processor and/or across multiple processors, as a stand-alone software package or as part of another software package.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of licensing software to multiple user classes, the method comprising:
collecting a software license fee corresponding to a software application from a key user interested in using and/or licensing the software application; and
collecting, from the key user, a priority usage-based license fee corresponding to usage of the software application by a priority user.

2. The method of claim 1, further comprising collecting, from the key user, a non-priority usage-based license fee corresponding to usage of the software application by a non-priority user.

3. The method of claim 2, wherein the priority user contributes value to the software application and wherein the priority usage-based license fee is assessed at a priority fee rate that is different than a non-priority fee rate corresponding to a non-priority usage-based license fee.

4. The method of claim 3, wherein the priority usage-based license fee is assessed at a priority fee rate that is lower than a non-priority fee rate corresponding to a non-priority usage-based license fee.

5. The method of claim 3, wherein the priority user contributes value to the software application by populating a database with information.

6. The method of claim 1, wherein the usage-based license fee comprises a per click fee.

7. The method of claim 1, wherein the usage-based license fee comprises a fee corresponding to a quantity of files transferred.

8. The method of claim 1, wherein the key user comprises a first supply chain party who derives benefit from usage of the software application by the priority user.

9. The method of claim 8, wherein the first supply chain party comprises a product manufacturer and/or product brand owner who is legally obligated to verify product authenticity and/or provide a record of product delivery status.

10. The method of claim 9, wherein the record of product delivery status comprises product location.

11. The method of claim 1, wherein the software application comprises a tracking and/or authenticating application, wherein the key user comprises a manufacturer and/or product brand owner, wherein the priority user contributes data corresponding to delivery status of a product, and wherein the non-priority user comprises a consumer.

12. A computer program product, the computer program product comprising a computer usable storage medium having computer-readable program code embodied in the medium, the computer readable program code configured to perform the method of claim 1.

13. A method of licensing a software application, to multiple user classes, wherein the software application is configured to store, in a database on a server, a unique identifier corresponding to a product, connect to the server, and access related information corresponding to the unique identifier, the method comprising:
collecting a software license fee corresponding to a software application from a key user interested in using the software application; and
collecting, from the key user, a usage-based license fee corresponding to usage of the software application by a non-key user.

14. The method of claim 13, wherein the usage-based license fee comprises a per click license fee corresponding to a quantity of functions accessed by the non-key user.

15. The method of claim 13, wherein the usage-based license fee comprises a per file license fee corresponding to a quantity of files and/or bytes accessed by the non-key user.

16. The method of claim 13, wherein the non-key user comprises a priority user who provides value to the software application by providing data to the database.

17. The method of claim 13, wherein the non-key user comprises a non-priority user having an interest in specific data contained within the database.

18. A computer program product, the computer program product comprising a computer usable storage medium having computer-readable program code embodied in the medium, the computer readable program code configured to perform the method of claim 13.

19. A method of licensing software to multiple user classes, the method comprising:
billing a license fee to a key user for use of a software application;
receiving, by a provider of the software application, value to the software application from a priority user;
providing the priority user access to the software application;
billing a priority user usage-based license fee to the key user based on usage of the software application by the priority user;
providing a non-priority user access to the software application; and
billing a non-priority user usage-based license fee to the key user based on usage of the software application by the non-priority user.

20. The method of claim 19, wherein the priority user usage-based license fee is determined by a priority user rate, wherein the non-priority user usage-based license fee is determined by a non-priority user rate, and wherein the priority user rate is different than the non-priority user rate.

21. The method of claim 19, wherein the software application comprises a database and wherein the value received from the priority user comprises data configured to be received by the database.

22. The method of claim 19, further comprising billing a portion of the priority user usage-based license fee to the priority user based on usage of the software application by the priority user.
